(19) United States
(12) Patent Application Publication
(10) Pub. No.: US 2024/0184831 A1
(43) Pub. Date: Jun. 6, 2024

(54) INTERACTIVE DATA CONNECTORS FOR AN ELECTRONIC DOCUMENT AT A PLATFORM

(71) Applicant: Google LLC, Mountain View, CA (US)

(72) Inventors: Behnoosh Hariri, New York, NY (US); Yu Xin Cheng, Kitchener (CA); Sebastian Marcin Kozlowski, Mountain View, CA (US); Miles Henrichs, New York, NY (US); Juntae Park, Hamilton (CA); Gregory George Galante, Little Silver, NJ (US); Donald Howard, Waterloo (CA); Dennis Jing Jing Liang, Mississauga (CA); Bikin Chiu, Mississauga (CA)

(21) Appl. No.: 18/525,222

(22) Filed: Nov. 30, 2023

Related U.S. Application Data
(60) Provisional application No. 63/385,945, filed on Dec. 2, 2022.

(51) Int. Cl. G06F 16/93; G06F 16/955

(52) U.S. Cl. CPC G06F 16/93; G06F 16/955

(57) ABSTRACT

A client device is provided with access to an electronic document using a user interface (UI) for a first application. The electronic document includes a reference to data associated with a second application. Upon detection of a first user interaction with a UI element associated with the reference to the data, the UI for the first application is updated to include, in the electronic document, at least a portion of the data associated with the second application. A request is received to modify data associated with the second application based on a second user interaction with the at least the portion of the data included in the electronic document. An instruction is transmitted to a computing system associated with the second application to modify the at least the portion of the data in accordance with the request.

### RELATED APPLICATIONS

This non-provisional application claims priority to U.S. Provisional Patent Application No. 63/385,945 filed on Dec. 2, 2022 and entitled “INTERACTIVE DATA CONNECTORS FOR AN ELECTRONIC DOCUMENT AT A PLATFORM,” which is incorporated by reference herein.

### TECHNICAL FIELD

Aspects and implementations of the present disclosure relate to interactive data connectors for an electronic document at a platform.

### BACKGROUND

A platform (e.g., an electronic document platform, etc.) can enable users to access electronic documents associated with the platform. For example, the platform can provide a user with access to an application (e.g., a collaborative document application) that enables the user to view, edit, or otherwise access an electronic document. In some instances, a user may want to add or modify content of the electronic document to include or otherwise corresponds to data associated with another application (e.g., of the platform, associated with another platform, etc.). It can be difficult for a user to identify data for inclusion in the content of the electronic document and integrate the data into the content of the electronic document.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for interactive data connectors for an electronic document at a platform. The method includes providing a client device with access to an electronic document using a user interface (UI) for a first application. The electronic document includes a reference to a set of data associated with a second application. The method further includes, upon detecting a first user interaction with a UI element associated with the reference to the set of data, updating the UI for the first application to include, in the electronic document, at least a portion of the set of data associated with the second application. The method further includes receiving a request to modify the set of data associated with the second application based on a second user interaction with the at least the portion of the set of data included in the the electronic document. The method further includes transmitting an instruction to a computing system associated with the second application to modify the at least the portion of the set of data in accordance with the request.

In some implementations, updating the UI for the first application to include the at least the portion of the set of data in the electronic document include identifying, from a template library, a template associated with the second application that corresponds to the set of data. The at least the portion of the set of data is included according to the identified template.

In some implementations, the method further includes determining whether the client device satisfies one or more authorization criteria associated with the second application. The UI for the first application is updated based on the determination.

In some implementations, determining whether the client device satisfies one or more authorization criteria associated with the second application includes determining that the client device is associated with a user account of the second application, and determining that an authorization process associated with the user account of the second application has completed.

In some implementations, the reference to the set of data associated with the second application includes a uniform resource locator (URL) associated with a web page that includes the set of data.

In some implementations, the UI element is a second UI element, and the method further includes determining that the electronic document includes the reference to the set of data associated with the second application. The method further includes, responsive to determining that the reference is supported by the second application, updating the UI for the first application to include a first UI element. The method further includes, responsive to a user interaction with the first UI element, obtaining, from the second application, data associated with rendering the second UI element associated with the reference to the set of data. The method further includes updating the UI for the first application to include the second UI element.

In some implementations, the method further includes detecting an error associated with at least one of the second application, the at least the portion of the set of data associated with the second application, or the second UI element. The method further includes responsive to the detection, updating the UI to replace the second UI element with the first UI element.

In some implementations, the detecting the first user interaction with the UI element includes at least one of: detecting that a user has engaged with the UI element via the UI, or detecting that the user has moved at least one of a mouse or a cursor of a peripheral device of the client device to a region of the UI that is adjacent to the UI element.

In some implementations, the UI for the first application is updated to include the at least the portion of the set of data with the reference to the set of data.

In some implementations, the UI for the first application is updated to replace the reference to the set of data with the at least the portion of the set of data.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform and an example data connector engine, in accordance with implementations of the present disclosure.

FIG. 3 depicts a flow diagram of an example method for interactive data connectors for an electronic document at a platform, in accordance with implementations of the present disclosure.

FIGS. 4A-4B illustrate example data of a third party application, in accordance with implementations of the present disclosure.

FIGS. 5A-5B illustrate example interactive data connectors in an electronic document, in accordance with implementations of the present disclosure.

FIGS. 6A-6C illustrate additional examples of interactive data connectors in an electronic document, in accordance with implementations of the present disclosure.

FIG. 7 depicts a flow diagram of another example method for interactive data connectors for an electronic document at a platform, in accordance with implementations of the present disclosure.

FIG. 8 is a block diagram illustrating an exemplary computer system, in accordance with implementations of the present disclosure.

### DETAILED DESCRIPTION OF THE DRAWINGS

Aspects of the present disclosure generally relate to interactive data connectors for an electronic document at a platform. A platform (e.g., a cloud-based collaboration platform) can provide a user with access to electronic documents. For example, the platform can provide a user with access to an application (e.g., a collaborative document application) that enables the user to view, edit, or otherwise access content of an electronic document via a client device of the user. A user can edit content of an electronic document by adding content to the electronic document, modifying or updating content of the electronic document, and/or removing content from the electronic document (e.g., using tools of the collaborative document application). As provided herein, an application of a platform that enables a user to access an electronic document is referred to as a “first party application.” A first party application can also be referred to as a “native application.”

Some users access electronic documents of a collaboration platform to organize information associated with one or more data sources that are separate or remote from the platform (and/or the first party application of the platform). For example, a user can edit an electronic document to include data associated with a data source that is not provided or otherwise hosted by the platform. The data source can store information that is publicly accessible and/or can store information (e.g., protected information) hosted by an application that is separate from the platform (also referred to as a third party application). To edit the electronic document, the user navigates to the data of the data source (e.g., via a webpage or via the third party application) and can manually integrate the data from the data source to the electronic document (e.g., by copying the data from the data source and pasting the data into the content of the electronic document). In another example, the user can edit the electronic document to include a reference to the data source, such as a uniform resource locator (URL) associated with a webpage for the data source. To access the data of the data source, the user can engage with (e.g., click, select, tap, etc.) the reference included in the content of the electronic document. Upon detecting a user engagement, the client device of the user can update a user interface (UI) to present the referenced data via another electronic document and/or a third party application.

As indicated above, it can take a significant amount of time for a user to navigate through a data source to identify data for inclusion in the content of the electronic document of the first party application. Navigating through the data source can disrupt a workflow of the user, which can cause the user to spend additional time editing the document to identify and organize data of the data source. A large amount of computing resources (e.g., processing cycles, memory space, etc.) can be consumed as the user spends additional time editing the electronic document, which can make such computing resources unavailable to other processes of the computing system. Further, navigating through the data source to identify the data can involve a complex set of interface selections, which can consume additional computing resources (e.g., associated with the first party application and/or the third party application). The unavailability of such computing resources to other processes of the computing system can increase an overall latency of the computing system and can decrease an overall efficiency of the computing system.

As indicated above, the user can include a reference to a data source that includes the data of interest in the content of an electronic document. However, the data can be updated or moved over time, and the reference may not be updated to reflect this. Accordingly, the reference to the data source is ineffective to identify the data of interest to the user, and the computing resources consumed to edit the electronic document to include the reference and/or access the data source via the reference are wasted. Further the reference may indicate a location of a large data set that includes the data for inclusion in the electronic document. When the user engages with the reference, the client device can update the UI to present the entire data set. It can take the user a significant amount of time to parse through the data set to identify the data of interest, which can consume even more computing resources. As described above, the consumption of computing resources relating to the reference for the data store can increase the overall latency and decrease the overall efficiency of the computing system, as described above.

Finally, conventional techniques only enable the user to include a copy or a reference of data of a data source and do not enable the user to update the data of the data source via the electronic document of the first party application. For example, after copying data from, or including a reference to, a data source of a third party application in an electronic document of a first party application, the user may wish to update at least a portion of the data. To do so, the user navigates through the data source to identify the copied or referenced data, updates the identified data (e.g., using tools of the third party application), and, in some instances, copies the updated data from the data source to the electronic document of the first party application. Such navigating and updating consumes even more computing resources, which further increases the overall system latency and decreases the overall system efficiency.

Embodiments of the present disclosure use an object (also referred to herein as a “chip”) to connect content of an electronic document to an external data source. In some embodiments, a user can update an electronic document of an application (e.g., a first party application) to include a reference (e.g. a URL) to data of a data source that is separate or remote from a platform of the first party application. The data source may store publicly accessible data and/or protected data hosted by an application that is separate from the platform (e.g., a third party application). Upon detecting a user interaction with the reference in the electronic document (e.g., via a first party application UI), the platform can transmit a request for the data associated with the reference to a computing system (e.g., another platform, a remote computing system, etc.) associated with the data source. Upon obtaining the data (or obtaining access to the data) of the data source, the platform can update the first party application UI to include a UI element that displays the data at the data source, as described herein. Such UI element can represent the chip that connects the content of the electronic document to the electronic data source.

In some embodiments, the platform can maintain a template library that includes one or more templates associated with a third party application that provides or otherwise hosts the data source. Each template of the template library can correspond to a particular type or category of data of the data source, in some embodiments. Each template of the template library can define a format or style of a chip included in the content of the electronic document, as described herein. In some embodiments, the platform can identify a template from the template library that corresponds to a type or category of the data associated with the referenced in the electronic document.

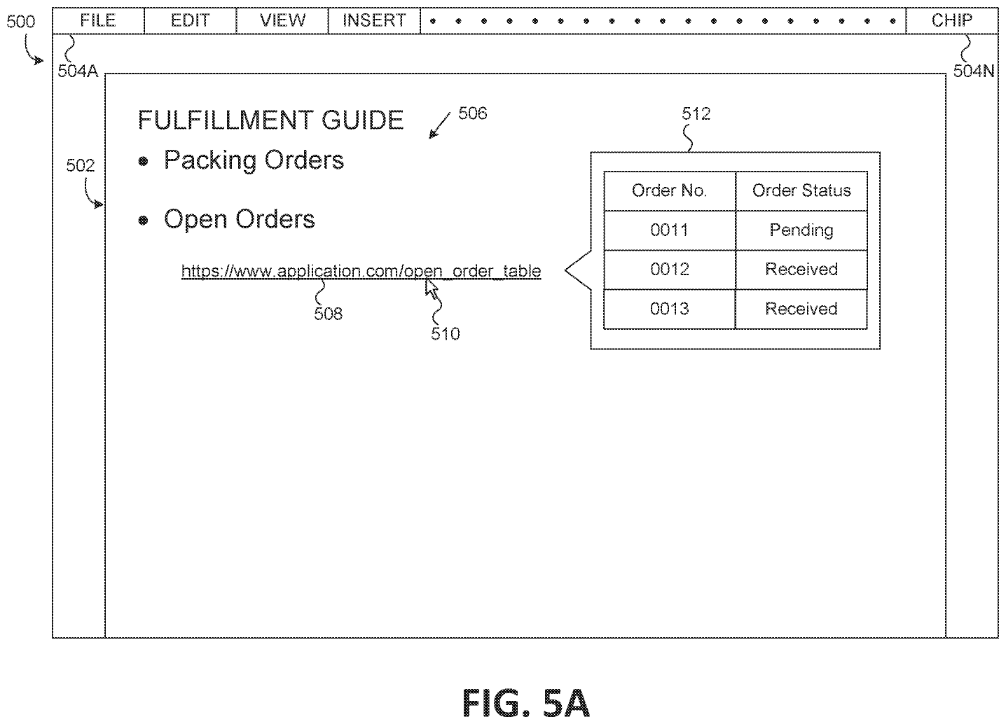

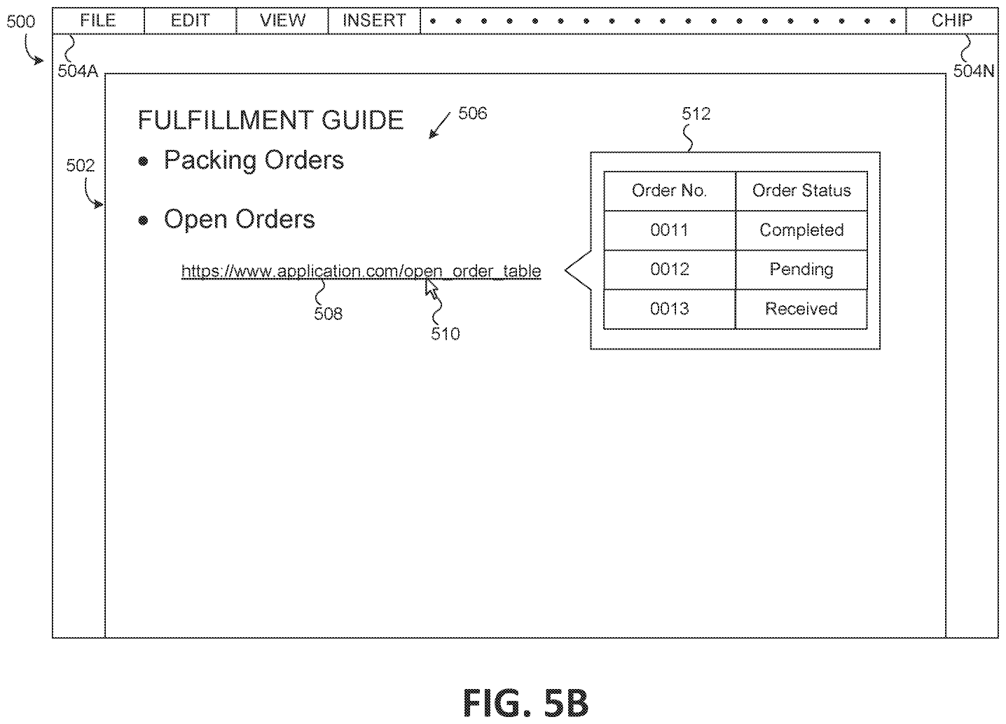

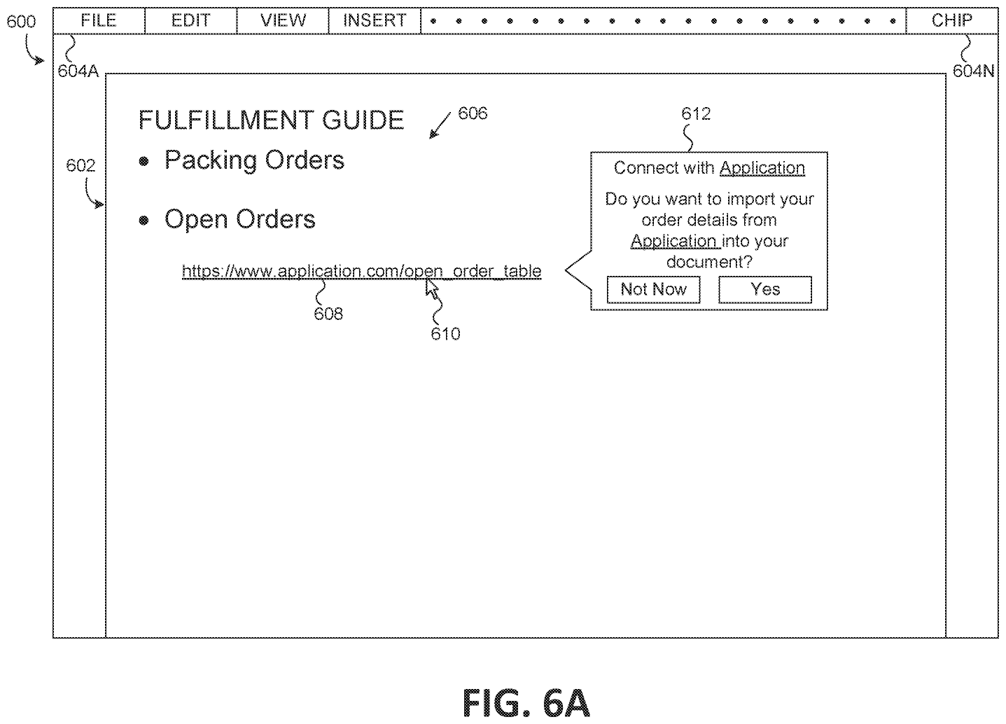

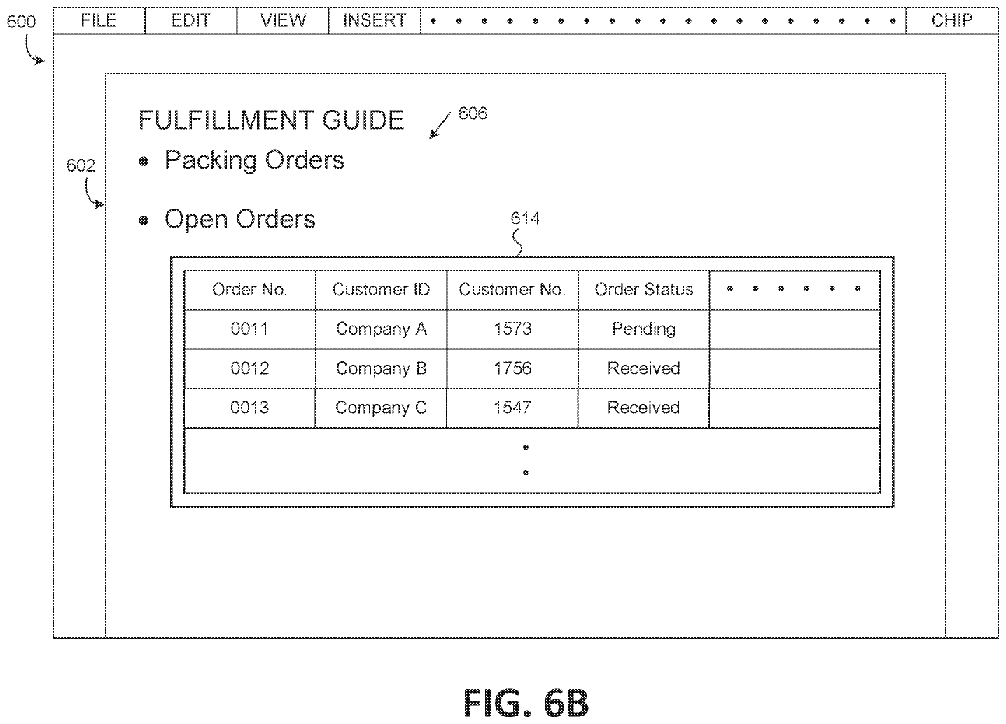

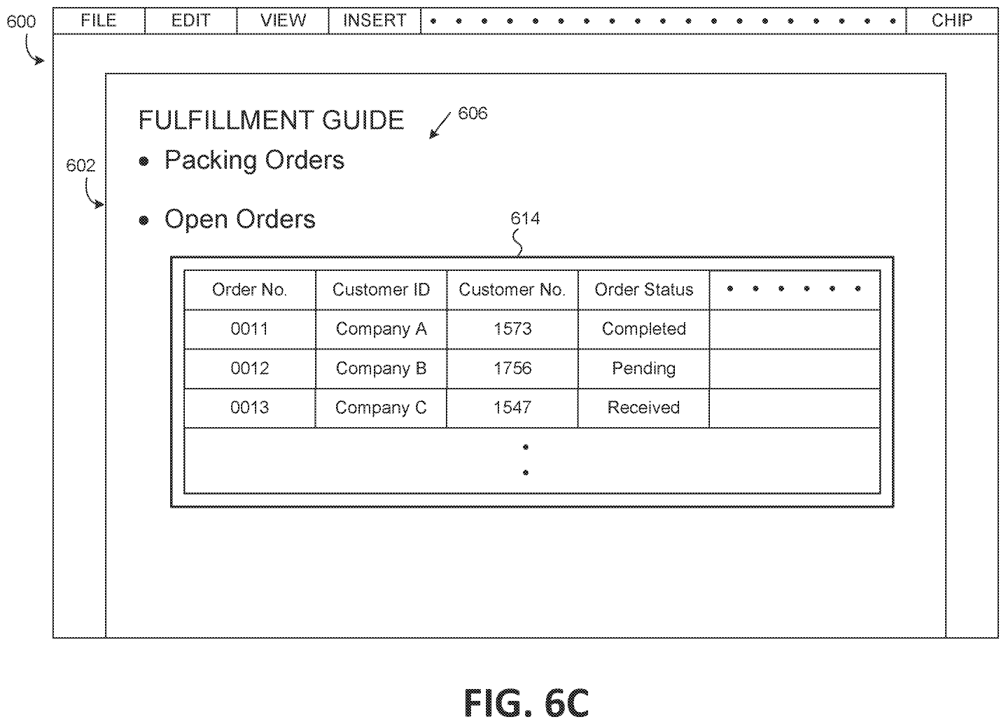

As indicated above, the platform can update the first party application UI to include at least a portion of the data provided by the third party application. In some embodiments, the platform can update the UI to include an additional UI element that provides the portion of the data (e.g., according to the identified template from the template library). The additional UI element can represent or otherwise correspond to the chip, which connects the reference in the electronic document of the first party application with the region of the data source of the third party application that includes the referenced data. The additional UI element can be provided with the reference to the data source (e.g., “hovering” over the data source URL) or can replace the UI element associated with the reference to the data source, in some embodiments. Further details regarding the presentation of the data received from the third party application are described with respect to FIGS. 5A-6C.

In some embodiments, the additional UI element can include one or more UI components that enable the user to engage with and/or modify the data presented via the additional UI element in the first party application UI. Upon detecting that the user has engaged with a UI component of the additional UI element, the client device of the user can transmit a request to the platform to modify the data corresponding to the UI component, per the user engagement. The platform can transmit an instruction to the computing system associated with the third party application to update the set of data associated with the reference in accordance with the request. The third party application can update the set of data at the data source, in accordance with the request.

In some embodiments, data of the data source can be updated according to other techniques pertaining to the third party application. For example, another user of the third party application can update the data of the data source, such that the portion of the data presented via the additional UI element is no longer relevant or up to date. Upon detection that the portion of the data has been updated, the computing system of the third party application can transmit a notification of the update to the platform. The platform can update the additional UI element (e.g., automatically or without user interaction) to include the updated data of the notification from the computing system. Accordingly, the data presented via the additional UI element can up to date with respect to the data of the data source, per the connection provided by the chip.

In an illustrative example, the reference included in the electronic document can be associated with a table or other such data structure maintained by a third party application. According to embodiments of the present disclosure, the platform can update the first party application UI to include at least a portion of the data of the table in the content of the electronic document (e.g., via the chip that connects the data of the table to the electronic document). The user can interact with the portion of the data of the table included in the content of the electronic document, as described herein.

Aspects of the present disclosure address the above mentioned deficiencies by providing techniques that enable a user to access up-to-date data from a data source of a third party application via a reference to the data source in content of an electronic document. As described above, embodiments of the present disclosure relate to a chip that facilitates the connection between a reference to data associated with a third party application and a data source of the third party application that stores the referenced data. In accordance with embodiments describe herein, the chip can enable the platform to provide a user with access to referenced data for a third party application in a UI of a first party application, which prevents the user from navigating the data source of the third party application and integrating (e.g., copying) the data into the content of the electronic document. Accordingly, a user can spend less time accessing and organizing data in an electronic document, which can improve a workflow of the user and reduce an overall amount of computing resources consumed by a platform hosting the first party application. The reduction in the amount of computing resources consumed by the platform makes such computing resources available to other processes, which decreases an overall latency and increases an overall efficiency of the computing system.

Further, embodiments of the present disclosure provide techniques to enable a user to update data of a data source and/or access updated data of a data source via the chip facilitating the connection between the reference and the data source. As described above, embodiments of the present disclosure enable the user to update data of the data source via UI components of a UI element associated with or corresponding to the chip. Accordingly, the user can update the data source without navigating the third party application, which reduces the overall amount of computing system consumed by the platform and the computing system of the third party application. Embodiments further enable the platform to update the UI element to reflect updates made to the data source (e.g., according to tools of the third party application). Accordingly, the data that is presented via the UI element corresponding to the chip is up-to-date, and the computing resources consumed by the platform to present the UI element are not wasted. Such conservation/reduction of computing resources by the platform and/or the computing system of the third party application further decreases an overall latency and further increases an overall efficiency of the computing system.

In this way, managing data from a variety of sources can be facilitated in an efficient and seamless manner. For instance, implementations described herein can reduce the number of user interactions required to manage (e.g., view, edit, etc.) data from a variety of sources. This can be the case, for example, because the user is provided with a mechanism by which they can interact with the external data of the third party application via an object (e.g., the chip described herein) of an application, rather than, for instance, needing to open the third party application in a new window in the UI, authenticating their identity for the third party application, and manually providing the data from the third party application. Furthermore, computational resources which would otherwise be consumed as a result of the additional interactions (e.g., in switching between the application for the platform and the third party application) can be conserved.

Furthermore, implementations described herein may assist a user in performing a technical task by means of a continued and/or guided human-machine interaction process, in an objective manner. For instance, the various graphical user interface elements and objects described herein can assist a user in connecting a document with an external data source where data from the external data source is editable using the document. The various graphical user interface elements and objects described herein can also assist the user in interacting (e.g., viewing, editing, etc.) with the data (e.g., via interacting with the object).

In addition, implementations described herein provide a mechanism enabling user input. For instance, the object (or chip) described herein can provide a mechanism enabling the user to interact with external data of a third party application (e.g., by making a selection, entering text, etc.).

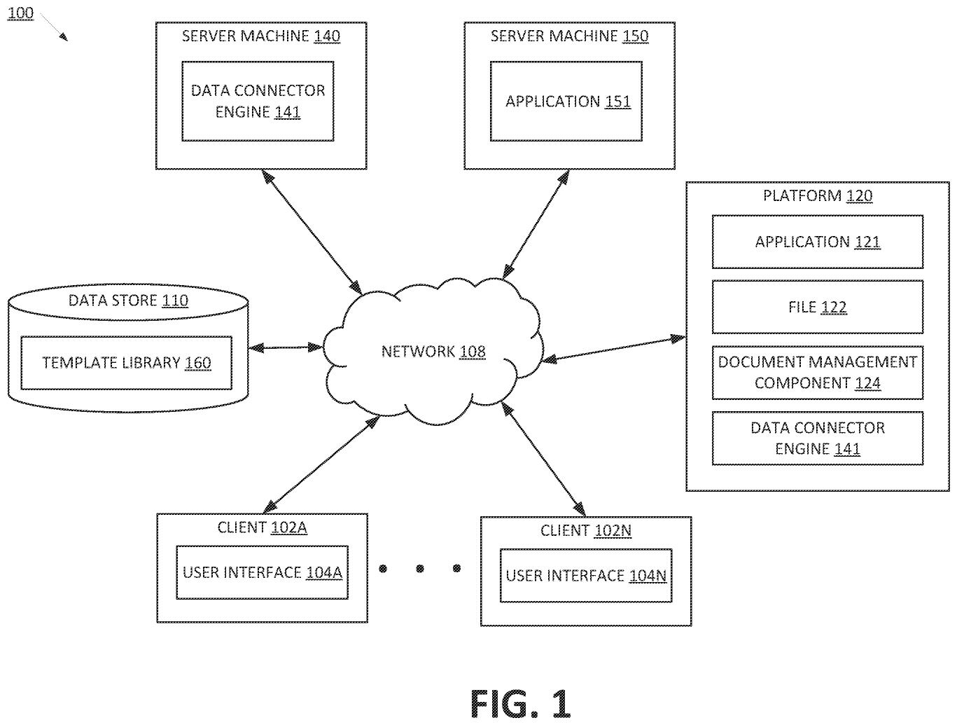

FIG. 1 illustrates an example system architecture 100, in accordance with implementations of the present disclosure. The system architecture 100 (also referred to as “system” herein) includes client devices 102A-N, a data store 110, a platform 120, a server machine 140, and/or a server machine 150 each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document displayed via a user interface (UI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Each client device can include a content viewer. In some embodiments, a content viewer can be an application that provides a user interface (UI) 104 for users to view, create, or edit content of a file 122, such as an electronic document file, an electronic message file (e.g., an email file), an image file, a video file, etc. For example, the content viewer can be a web browser that can access, retrieve, present, and/or navigate files 122 served by a web server. The content viewer can render, display, and/or present the content of a file 122 to a user. In one example, the content viewer can be a standalone application, such as application 121 (e.g., a mobile application or app) that allows users to view, edit, and/or create digital content items (e.g., electronic documents, electronic messages, digital video items, digital images, electronic books, etc.). In some implementations, the content viewer can be an electronic document platform application for users to generate, edit, and/or upload content for electronic documents on the platform 120. In other or similar implementations, the content viewer can be an electronic messaging platform application (e.g., an electronic mail (e-mail) application) for users to generate and send messages via platform 120. As such, the content viewers can be provided to the client devices 102A-102N by platform 120.

In some implementations, platform 120, server machine 140, and/or server machine 150 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file 122 (e.g., an electronic document, an e-mail message, etc.) and/or provide the file 122 to the user. For example, platform 120 can be an electronic document platform, such as a collaborative document platform. The electronic document platform may allow a user to create, edit (e.g., collaboratively with other users), access or share with other users an electronic document stored at data store 110. In another example, platform 120 can be an electronic messaging platform (e.g., e-mail platform). The electronic messaging platform can allow a user to create, edit, or access electronic messages (e.g., e-mails) addressed to other users of the electronic messaging platform or users of client devices outside of the electronic messaging platform. Platform 120 can also include a website (e.g., a webpage) or application back-end software that can be used to provide a user with access to files 122.

As illustrated in FIG. 1, platform 120 can include a document management component 124, in some embodiments. Document management component 124 can be configured to manage access to a particular document by a user of platform 120. For example, a client device 102 can provide a request to platform 120 for a particular file 122 corresponding to an electronic document. Document management component 124 can identify the file 122 (e.g., stored in data store 110) and can determine whether a user associated with the client device 102 is authorized to access the requested file 122. Responsive to determining that the user is authorized to access the requested file 122, document management component 124 can provide access to the file 122 to the client device 102. The client device 102 can provide the user with access to the file via the UI 104 of an application 121 associated with platform 120, as described above. Application 121 of platform 120 is sometimes referred to herein as first party application 121.

As indicated above, a user can create and/or edit an electronic document (e.g., of file 122) via a UI 104 of first party application 121 (also referred to herein as a first party application UI 104) at a client device 102 associated with the user. The electronic document can include content, in some embodiments. Content can include one or more text strings, images, videos, graphics, etc. In some embodiments, the electronic document can be or can correspond to a word document, slide presentation document, a spreadsheet document, a web page document, an electronic message document, and so forth. Platform 120 can provide a user with access to application 121, which includes tools that enable a user to create and/or edit an electronic document. In one example, a client device 102A associated with a user of platform 120 can transmit a request to platform 120 to create a word document based on a word document template associated with platform 120. Platform 120 can generate a file 122 associated with the word document based on the word document template and can provide the user with access to the word document via the first party application UI 104. In another example, a client device 102 associated with a user of platform 120 can transmit a request to access an electronic document (e.g., a word document) via the first party application UI 104. Document management component 124 can obtain the file 122 associated with the requested electronic document, as described above, and platform 120 can provide the user with access to the electronic document via the first party application UI 104. The user can edit one or more portions of the electronic document via the first party application UI 104 and the platform 120 can update the file 122 associated with the electronic document to include the edits to the one or more portions. The electronic document can be a collaborative document that, in some embodiments, can be edited (e.g., concurrently) by one or more users of platform 120.

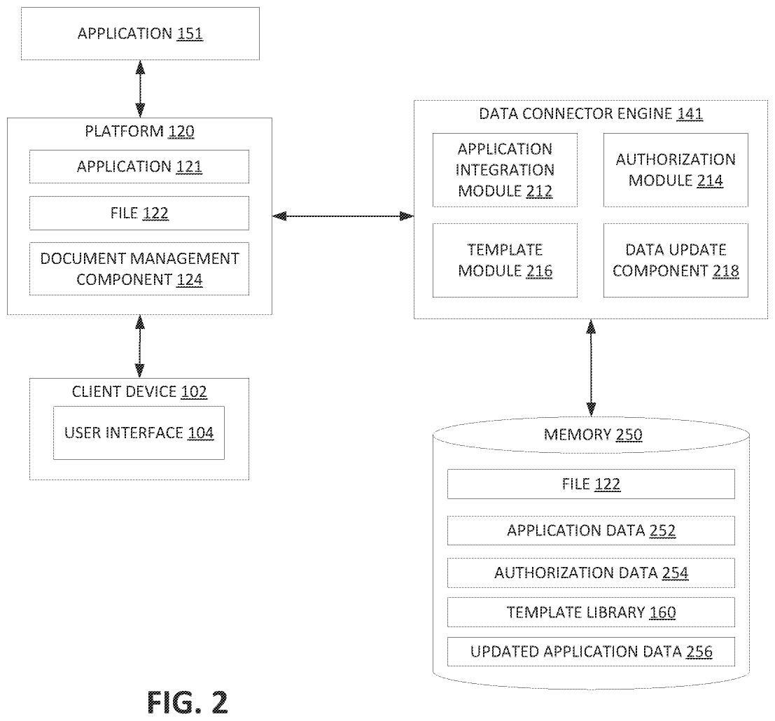

In some embodiments, a user can update content of an electronic document to include a reference (e.g., a URL) to data at a data source associated with an application 151 that is separate or remote from platform 120. Such applications 151 are also referred to herein as third party applications 151. As illustrated in FIG. 1, platform 120 can include a data connector engine 141. The data connector engine 141 can manage data connections between file 122 and a data source of third party application 151, as described herein. In additional or alternative embodiments, a template library 160 can be stored at data store 110. The template library 160 can be maintained and/or otherwise accessible to platform 120 (e.g., via network 108, via a bus, etc.). The template library 160 can include templates associated with one or more third party applications 151 that are used for connecting data associated with applications 151 with a file 122 of platform 120. Further details regarding data connector engine 141 and template library 160 are described herein with respect to FIGS. 2-7.

It should be noted that in some other implementations, the functions of server machines 140, 150, and/or platform 120 can be provided by a fewer number of machines. For example, in some implementations, server machines 140 and/or 150 may be integrated into a single machine, while in other implementations server machines 140 and/or 150 may be integrated into multiple machines. In addition, in some implementations one or more of server machines 140 and/or 150 may be integrated into platform 120.

In general, functions described in implementations as being performed by platform 120 and/or server machines 140 and/or 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing an electronic document, implementations can also be generally applied to any type of documents or files. Implementations of the disclosure are not limited to electronic document platforms that track approvals for an electronic document.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

In some cases, a third-party application is one or more computer-implemented processes that define one or more APIs or programmatic interfaces that differ(s) from one or more APIs/programmatic interfaces provided by the first-party application. For example, in an embodiment the third-party application 151 is an application that programmatically defines and provides a set of APIs that are distinct from the APIs natively exposed or supported by the application(s) of platform 120).

FIG. 2 is a block diagram of an example data connector engine 141, in accordance with implementations of the present disclosure. As described above, data connector engine 141 can manage data connections between a file 122 and an external data source. In some embodiments, the data connection can be represented by or can otherwise correspond to an object (also referred to herein as a “chip”) that indicates a connection of data included in a content of an electronic document to an external data source. In some embodiments, the external data source can be associated with an application that is separate or remote from platform 120. As indicated above, such application is referred to herein as application 151.

As illustrated in FIG. 2, data connector engine 141 can include an application integration module 212, an authorization module 214, a template identifier module 216, and a data update component 218. Details regarding data connector engine 141 are described below with respect to FIGS. 2, 3, and 4A-6C. In some embodiments, platform 120 and/or data connector engine 141 can be connected to memory 250 (e.g., via network 108, via a bus, etc.). Memory 250 can correspond to one or more regions of data store 110, in some embodiments. In other or similar embodiments, one or more portions of memory 250 can include or otherwise correspond any memory of or connected to system 100.

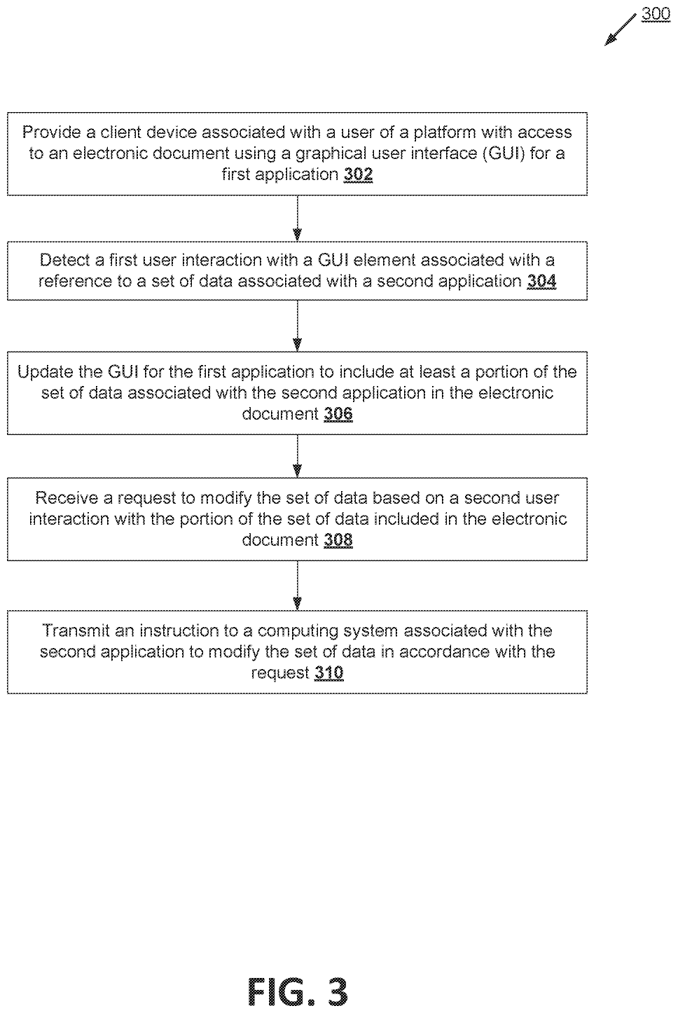

FIG. 3 depicts a flow diagram of an example method 300 for interactive data connectors for an electronic document at a platform, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by platform 120 and/or data connector engine 141.

At block 302, processing logic provides a client device associated with a user of a platform with access to an electronic document using a UI for a first application. As described above, document management component 124 of platform 120 can manage access to one or more electronic documents by a user of platform 120. For example, a client device 102 can request access to an electronic document, e.g., based on a user interaction with one or more UI elements of a user interface 104 of a first party application 121. Upon receiving the request, document management component 124 can identify a file 122 (e.g., at memory 250, at data store 110, etc.) and, in some embodiments, can determine whether the client device 102 and/or the user is authorized to access the electronic document. In some embodiments, document component 124 can determine whether a client device 102 and/or a user is authorized to access the electronic document by determining whether the client device 102 and/or the user satisfy one or more permission criteria associated with the electronic document. In some embodiments, memory 250 and/or data store 110 can store metadata associated with a file 122 for an electronic document. The metadata can include permission or authorization data, that indicates one or more client devices 102 and/or users that are permitted to access the electronic document. In some embodiments, the metadata can include an identifier associated with a client device 102 and/or a user that is permitted to access the electronic document. Document management component 124 can determine an identifier associated with the client device 102 and/or the user that provided the request to access the electronic document and determine whether the determined identifier corresponds to an identifier of the metadata for file 122. Upon determining that the determined identifier corresponds to an identifier of the metadata, document management component 124 can determine that the client device 102 and/or the user is permitted or authorized to access the electronic document. In such embodiments, data management component 124 can retrieve the file 122 associated with the electronic document from memory 250 and can provide one or more portions of the retrieved file 122 to client device 102. Upon determining that the determined identifier does not correspond to an identifier of the metadata, document management component 124 can provide a notification to client device 102 that the client device 102 and/or the user is not authorized to access the electronic document.

In other or similar embodiments, client device 102 can include a cryptographic key and/or an authorization token in the request to access the electronic document. Document management component 124 can compare the cryptographic key and/or the authorization token to cryptographic data and/or authorization data associated with the file 122 to determine whether the client device 102 and/or the user is authorized to access the electronic document. Document management component 124 can grant/deny access to the electronic document, as described above, based on the comparison, in some embodiments. It should be noted that document management component 124 can determine whether the client device 102 and/or the user is authorized to access the electronic document according to other techniques.

In some embodiments, the electronic document that is provided to the user of client device 102 can include content. For example, the user, or another user of platform 120, can update the electronic document to include content (e.g., text content, image content, etc.) and a client device 102 of the user (or the other user) can provide the content to platform 120 for storage in file 122 (e.g., at memory 250, at data store 110, etc.). Document management component 124 can provide the electronic document to client device 102 (e.g., in response to the request from client device 102, as described above) and client device 102 can present the content of the electronic document to the user via the user interface 104 of client device 104. The user can view and/or edit the content of the electronic document using the tools of the first party application 121, as described herein. In other or similar embodiments, the electronic document provided to the user of client device 102 in accordance with the above described request may not include content. In such embodiments, the user can update the electronic document to include content (e.g., text content, image content, etc.), as described herein.

In some embodiments, the content of the electronic document (e.g., viewed or edited by the user of client device 102) can include a reference to data associated with a data source that is separate or remote from platform 120. Such data source is referred to herein as an external data source. In some embodiments, the external data source can be a publicly accessible data source that is available to users via a web page or other such document. In other or similar embodiments, the external data source can be associated with an application 151 that is managed or hosted by a computing system that is separate from platform 120 (e.g., a third party application 151). It should be noted that although some embodiments of the present disclosure are described with respect to a data source of a third party application 151, embodiments of the present disclosure can be applied for any data source that is separate or remote from platform 120 and/or a first party application 121 of platform 120. A third party application 151 can include any type of application. In one illustrative example, the third party application 151 includes a customer relationship management (CRM) application. The external data source of the third party application 151 can store data associated with features or a functionality of the CRM application.

A reference to the data of the external data source can include a reference or indication to a URL associated with the external data source, in some embodiments. For example, the reference can include a link or a hyperlink that indicates an address (e.g., a web address or URL, a memory address, etc.) for the external data source. As described above, in some embodiments, the reference can be included in the content of the electronic document that is provided to client device 102. In other or similar embodiments, a user that is accessing the electronic document can update the content of the electronic document to include the reference.

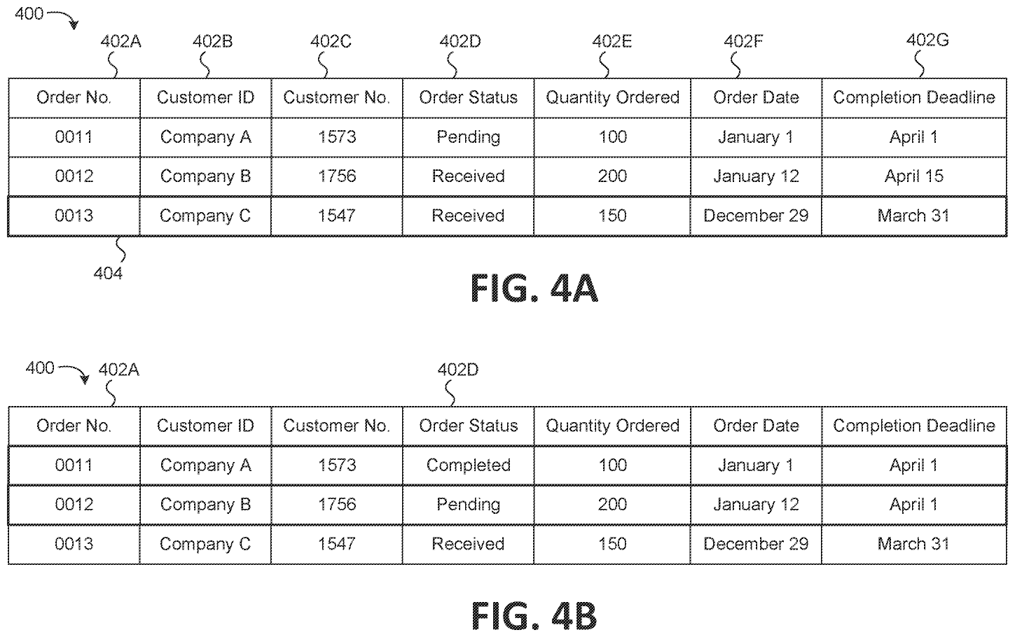

FIGS. 4A-4B illustrate example data of an external data source 400, in accordance with implementations of the present disclosure. In some embodiments, external data source 400 can include a data store or a database that stores information relating to a feature or functionality of a third party application 151. In accordance with a previous illustrative example, the third party application 151 can include a CRM application. In such example, external data source 400 can include a data store that stores information relating to orders and/or customers associated with the CRM application. As illustrated in FIG. 4A, the external data source 400 can include one or more entries 404, where each entry includes multiple fields relating to orders and/or customers associated with the CRM application. For example, each entry 404 of external data source 400 can include an order number field 402A, a customer identifier (ID) field 402B, a customer number field 402C, an order status field 402D, a quantity ordered field 402E, an order date field 402F, a completion deadline field 402G, and so forth. It should be noted that FIGS. 4A-4B are provided for the purpose of example and illustration only and that external data source 400 and/or entries 404 of external data source 400 can have any structure consistent with a data structure or database and/or can store any type of amount of information.

FIG. 5A illustrates an example electronic document provided via a UI 500 of a first party application 121 of a platform 120, in accordance with implementations of the present disclosure. As described above, UI 500 can enable a user to view, edit, or otherwise access an electronic document 502 using tools of the first party application 121. In some embodiments, UI 500 can include a toolbar that includes one or more menus 504 that enable users to access tools associated with the first party application 121. As illustrated in FIG. 5A, UI 500 can include a file menu 504A, an edit menu, a view menu, an insert menu, and so forth. In some embodiments, UI 500 can include a chip menu 504N, which enables a user to access one or more tools associated with a chip of electronic document 502, as described herein.

As illustrated in FIG. 5A, electronic document 502 can include content 506. Content 506 can include, but is not limited to, text content, image content, audio content, and so forth. In some embodiments, content 506 can include a reference 508 to an external data source. The reference 508 can be added to content 506 by a user of client device 102, as described above. The external data source can be associated with a third party application 151, in some embodiments. In accordance with previous illustrative examples, the reference 508 can include a URL or a hyperlink for an address (e.g., a web address) associated with the external data source. In some embodiments, reference 508 can include a URL or a hyperlink for an address associated with external data source 400 of FIGS. 4A-4B.

Referring back to FIG. 3, at block 304, processing logic detects a first user interaction with a UI element associated with a reference to a set of data associated with a second application. In some embodiments, client device 102 can enable a user to engage with one or more UI elements of a first party application UI 104. For example, client device 102 can include or can be connected to a peripheral device (e.g., a mouse, a keyboard, a touch screen, a microphone, a smart pen, etc.) that is controllable by a user to engage with one or more UI elements of UI 104. The user can engage with or otherwise interact with a UI element of UI 104 by clicking, selecting, tapping, etc. the UI elements, in some embodiments. In other or similar embodiments, the user can engage with or otherwise interact with the UI element by moving another UI element 510 (e.g., a pointer, a cursor, etc.) associated with the peripheral device to or around a region of the UI 104 that includes a UI element representing the reference to the external data source (e.g., hovering the pointer around the UI component). In accordance with the illustrative example of FIG. 5A, the user can engage with or otherwise interact with a UI element representing reference 508 by selecting, clicking, tapping, etc. the UI element and/or by moving the other UI element 510 around the UI element representing reference 508.

At block 306, processing logic updates the UI for the first application to include at least a portion of the set of data associated with the second application in the electronic document. Upon detecting the user interaction with the UI element associated with the reference to the external data source, client device 102 can transmit a request to platform 120 to access data of the external data source according to the reference. Application integration module 212 of data connector engine 141 can receive the request from client device 102, in some embodiments. Upon receiving the request, application integration module 212 can determine data of the external data source that is to be provided to the client device 102 in accordance with the request and can transmit another request to third party application 151 for the identified data. Such data is depicted in FIG. 2 as application data 252 (also referred to herein as third party data 252). In some embodiments, application integration module 212 can determine which data 252 of external data source 400 is to be provided to client device 102 based on the reference 508 included in the content 506 of electronic document 502. For example, the reference 508 can include a web address (e.g., a URL) or a memory address indicating a region or section of the external data source 400 that includes the data that is to be provided. Application integration module 212 can determine an application 151 associated with the reference 508 and/or can determine an address for the region of the external data source 400 based on the reference 508, in some embodiments. Upon determining the application 151 and/or the address for the region of external data source 400, application integration module 212 can transmit a request to application 151 for the data (e.g., via network 108).

In some embodiments, external data source 410 can be a protected data source that is only available to client devices 102 and/or users that have authorization or permission (e.g., from application 151, from a developer or operator of application 151, etc.). In some embodiments, application 151 can provide a request to data connector engine 141 for authorization data 254 associated with the client device 102 and/or the user (e.g., in response to the request for data 252). Authorization module 214 can provide the authorization data 254 to application 151 in response to the request, as described herein. In other or similar embodiments, authorization module 214 can provide the authorization data 254 with the request for data 252 to application 151, as described herein.

Authorization data 254 can include any data that is used by application 151 to authorize access by a client device 102 and/or a user to data of external data source 400. In some embodiments, application 151 can maintain or otherwise store (e.g., at memory 250 or at another memory) one or more identifiers associated with client devices 102 and/or users that are permitted to access data of external data source 400. Authorization data 254 can include an identifier associated with client device 102 and/or the user. Upon receiving authorization data 254, application 151 can compare the identifier of authorization data 254 to an identifier associated with the permitted client devices 102 and/or users to determine whether the client device 102 and/or the user is permitted to access external data source 400.

In other or similar embodiments, authorization data 254 can include cryptographic data, such as a cryptographic key and/or an authorization token. A cryptographic key refers to a string of characters or information that, which processed through a cryptographic algorithm, can encode or decode data. An authorization token can include data or code that, when accessed or executed by application 151, indicates to application 151 that the client device 102 and/or the user are permitted to access external data source 400. In some embodiments, application 151 can provide the cryptographic key and/or the authorization token to platform 120 (e.g., during an initialization process associated with application 121 and/or application 151). Upon receiving the cryptographic key and/or the authorization token, authorization module 214 can store the key and/or the token at memory 250 as authorization data 254. In some embodiments, authorization module 214 can store the key and/or the token at a region of memory 250 that is secure (e.g., inaccessible by other engines or components). In additional or alternative embodiments, application 151 can provide platform 120 with information that can be used to generate the cryptographic key and/or the authentication token. For example, application 151 can provide platform 120 with data that, when provided as an input to a cryptographic function, the function can output the cryptographic key and/or the authentication token. Authorization module 214 can apply the cryptographic to the data to obtain the cryptographic key and/or the authentication token and can store the key and/or the token at memory 250, as described above.

As indicated above, in some embodiments, authorization module 214 can provide the authorization data 254 to application 151 with the request for data 252 from application integration module 212. In other or similar embodiments, application integration module 212 can provide the request for data 252 to application 151. Upon receiving the request, application 151 can transmit another request to platform 120 for authorization data 254 to authorize whether the client device 102 and/or the user is permitted to access data of external data source 400. Authorization module 214 can provide authorization data 254 in accordance with the request from application 151. As described herein, application integration module 212 may issue subsequent requests for data 252. In some embodiments, authorization module 214 may provide authorization data 254 with (or responsive to) each subsequent request for data 252, as described herein. In other or similar embodiments, authorization module 214 may provide the authorization data 254 with (or responsive to) a subsequent request if a reauthorization criteria is satisfied, in accordance with an authorization protocol of application 151 and/or platform 120 (e.g., a time limit of the authorization protocol is expired, application integration module 212 has transmitted a threshold number of data access requests to application 151, etc.).

As described above, memory 250 and/or data store 110 can include a template library 160 that stores one or more templates associated with application 151. Each template of the template library can correspond to a particular type or category of the data of external data source 400. In some embodiments, a template can define a format or a style of a chip that is presented via a UI element of electronic document 502. In one example, a template can define a format or a style of a chip based on the organization of the data at external data source 400 that is referenced by reference 508. For instance, if data of external data source 400 is organized in a table, the template can define a format or style of table, for inclusion in the chip at electronic document 502. In another instance, the template can define particular fields 402 of entries 404 of external data source 400 that are to be included in the table of the chip at electronic document 252. Further details and examples regarding the templates are provided herein with respect to FIGS. 5A-6C below. In additional or alternative embodiments, a template can define a format or a style of a chip based on branding or logos pertaining to application 151. Templates of template library 160 can be provided to platform 120 by application 151, in some embodiments. In other or similar embodiments, template module 216 of data connector engine 141 can generate or update the templates of template library 160 based on historical or experimental data of platform 120 and/or application 151.

In some embodiments, template module 216 can identify a template of template library 160 that corresponds to the application data 252 that is requested by client device 102. In an illustrative example, client device 102 can request data 252 of an “open order table” managed by CRM application 151 (e.g., as illustrated by FIG. 4A). Template module 216 can identify a template of template library 160 that corresponds to data that is stored in a data structure having a table format, in some embodiments. In other or similar embodiments, template module 216 can identify a template of template library 160 that corresponds to data of the open order table. The identified template can define one or more fields 402 of external data structure 400 that are to be included in the chip at electronic document 502, as described herein.

In some embodiments, template module 216 can identify the template corresponding to application data 252 in response to application 151 providing the application data 252 to platform 120. In other or similar embodiments, template module 216 can identify the template prior to application integration module 212 providing the request to application 151 for application data 252. In such embodiments, template module 216 can determine the particular fields 402 of external data source 400 that are to be included in the chip at electronic document 502. The request provided by application integration module 212 can reference only the data that is included in the fields 402 determined by template module 216. Accordingly, the application data 252 provided by application 151 may include only the data in the determined fields 402, and may not include other data that is included in other fields 402 of the entries 404 of external data source 400.

Upon obtaining application data 252 from application 151, application integration module 212 can update UI 500 to include a UI element that represents the chip connecting electronic document 500 to external data source 400. As illustrated in the example of FIG. 5A, upon a user interaction with reference 508, data connector engine 141 can obtain data 252 associated with reference 508 and can update UI 500 to include a UI element 512 that presents data 252 in content 506 of electronic document 502. The UI element 512 can include or otherwise correspond to the chip that connects electronic document 502 to external data source 400. In some embodiments, data 252 can be presented according to the format or style of the identified template from template library 160. As illustrated in FIGS. 4A and 5A, external data source 400 can include multiple fields 402 for each entry 404. Data 252 of UI element 512 can be obtained from one or more particular fields 402 of external data source 400, as defined by the template. For example, data 252 can be obtained from field 402A (e.g., “order number” field) and/or field 402D (e.g., “order status” field).

Referring back to FIG. 3, at block 308, processing logic receives a request to modify the set of data based on a second user interaction with the portion of the set of data included in the second section of the electronic document. In some embodiments, the UI element 512 representing or corresponding to the chip that connects electronic document 502 to external data source 400 can include one or more UI components that enable a user to edit or modify data 252 at external data source 400. Such UI components of UI element 512 can be defined by the template of template library 160, in some embodiments. As illustrated in FIG. 5B, a user of client device 102 can edit or modify data 252 by engaging with one or more of the UI components of UI element 512. For example, the user can modify the “order status” field 402D of an entry 404 associated with order no. “0011” from “pending” to “completed,” as illustrated in FIG. 5B. In another example, the user can modify the “order status” field 402D of an entry 404 associated with order no. “0012” from “received” to “pending.”

At block 310, processing logic transmits an instruction to a computing system associated with the second application to modify the set of data in accordance with the request. Upon detecting that a user has modified data 252 by engaging with UI components of UI element 512, client device 102 can transmit a notification to platform 120 indicating the modification. In some embodiments, the notification can include the updated data (depicted as updated application data 256 of FIG. 2) and/or an indication of the fields 402 of external data source 400 associated with the updated data 256. Data update component 218 of data connector engine 141 can generate an instruction that, when executed, causes application 151 to update external data source 400 to include the updated application data 252. Upon generating the instruction, data update component 218 can transmit the instruction to application 151. A computing system supporting or hosting application 151 can execute the instruction, which can cause application 151 to update external data source 400 to include updated application data 256.

As illustrated in FIG. 4B, external data source 400 can be updated to include updated application data 256. For example, application 151, based on execution of the instruction from data update component 218, can update an “order status” field 402D of an entry 404 associated with order no. “0011” to include a value of “completed” (e.g., per the user modification via UI element 512). In another example, application 151, based on execution of the instruction from data update component 218, can update an “order status” field 402D of an entry 404 associated with order no. “0012” to include a value of “pending” (e.g., per the user modification via UI element 512). In some embodiments, updates to fields 502 by a user via UI element 512 can cause values of data in other fields to be modified (e.g., according to a formula or function associated with external data source 400). For example, upon updating the “order status” field 402D of an entry 404 associated with order no. “0012” to include the value of “pending,” application 151 can update the “completion deadline” field 402G for the entry 404 to have a value of “April 1” (e.g., according to a formula or function associated with external data source 400).

In some embodiments, a user of client device 102 and/or another user of application 151 can edit data of external data source 400 via application tools of application 151. For example, the user of client device 102 and/or another user can update data of one or more fields of external data source 400 using the tools of application 151. In some embodiments, application 151 can transmit a notification of an update to data of external data source 400 to data update component 218. Data update component 218 can update UI element 512 to include the updated data, upon receiving the update. Accordingly, embodiments of the present disclosure provide that application data 252 that is updated via UI element 512 and/or according to application tools of application 151 can be reflected in the content 506 of electronic document 502 and at external data source 400 (e.g., via the chip that connects electronic document 502 and external data source 400). In some embodiments, application 151 can provide the updated data 252 to data update component 218 upon detecting the update via tools of application 151. In other or similar embodiments, application 151 can provide the updated data 252 to data update component 218 as part of a periodic update (e.g., according to a data update protocol of application 151). In yet other or similar embodiments, data update component 218 can transmit an inquiry to application 151 of whether data of external data source 400 has been updated (e.g., according to a data update protocol of application 121 and/or platform 120).

FIGS. 6A-6C illustrate additional examples of interactive data connectors in an electronic document, in accordance with implementations of the present disclosure. FIG. 6A illustrates an example UI 600 of a first party application 121, as described above. As illustrated in FIG. 6A, UI 600 can include the same or similar features as UI 500, described with respect to FIGS. 5A and 5B. UI 600 can present content 606 of an electronic document 602 to a user of client device 102, as described above. In some embodiments, the content 606 can include a reference 608 to an external data source, such as external data source 400.

In accordance with previously described embodiments, client device 102 can detect that a user has engaged with a UI element associated with reference 608. For example, client device 102 can detect that the user has moved a UI element 610 associated with a peripheral device of or connected to client device 102 to a region of UI 600 that includes or is adjacent to reference 608. Upon client device 102 detecting that the user has engaged with the UI element associated with reference 608, platform 120 and/or data connector engine 141 can update UI 600 to include UI element 612. Additionally or alternatively, platform 120 and/or data connector engine 141 can update UI 600 to include UI element 612 responsive to determining that the electronic document 602 includes reference 608 (e.g., when a user updates electronic document 602 to include reference 608). In some embodiments, platform 120 and/or data connector engine 141 can also determine whether reference 608 is supported by application 151 prior to updating UI 600 to include UI element 612. As illustrated in FIG. 6A, UI element 612 can include a question or a prompt inquiring whether the user would like to import data from external data source 400 into document 602 (e.g., “Do you want to import your order details from Application into your document?”). UI element 612 can include one or more UI components that enable the user to indicate that they would like to import data from external data source 400 or that they would not like to import data from external data source 400. In an illustrative example, the user can select the “Yes” UI component of UI element 612 to indicate that they would like to import data from external data source 400.

In some embodiments, the question or prompt of UI element 612 can be provided with data of UI element 512 of FIG. 5A. For example, platform 120 can update UI 500 and/or 600 to include application data 252 upon detection that the user engaged with reference 508 and/or 608, as described above. Platform 120 can further update UI 500 and/or 600 to include the question or prompt inquiring ether the user would like to import data from external data source 400 into document 502 and/or 602. Platform 120 can incorporate application data 252 into content 506/606 of document 502/602 based on a user engagement with a UI component of UI element 512/612, as described below. In additional or alternative embodiments, a user can request to incorporate data 252 into the content 506/606 of document 502/602 based on a user interaction with menu 604N.

As illustrated in FIG. 6B, platform 120 and/or data connector engine 141 can update content 606 of electronic document 602 to include a UI element 612 that presents application data 252. In some embodiments, the application data 252 can be provided according to a template identified from template library 160, as described above. The UI element 614 can include the same data 252 that is included in UI element 512 and/or additional data 252. For example, UI element 614 can include data of “order no.” field 402A, “customer ID” field 402B, “customer no.” field 402C, “order status” field 402D, and so forth.

In accordance with previously described embodiments, UI element 614 can include one or more UI components that enable a user to edit data of external data source. For example, as illustrated by FIG. 6C, a user can edit or modify data of one or more fields 402 presented via UI element 614, as described above.

In some embodiments, data connector engine 141 can detect an error with respect to the connection between UI elements 512 and/or 614 and external data source 400. The error can occur based on one or more updates (e.g., software updates, firmware updates, etc.) associated with application 121 and/or application 151, in some embodiments. In other or similar embodiments, the error can occur based on a modification to an authorization status with respect to client device 102 and/or the user of client device 102. In some embodiments, the update can disrupt the connection between UI elements 512 and/or 615 and external data source 400 (e.g., via the chip). In such embodiments, platform 120 and/or client device 102 can update UI 500/600 to replace the UI elements 512 and/or 614 with the references 508/608 (e.g., URLs) to the external data source 400.

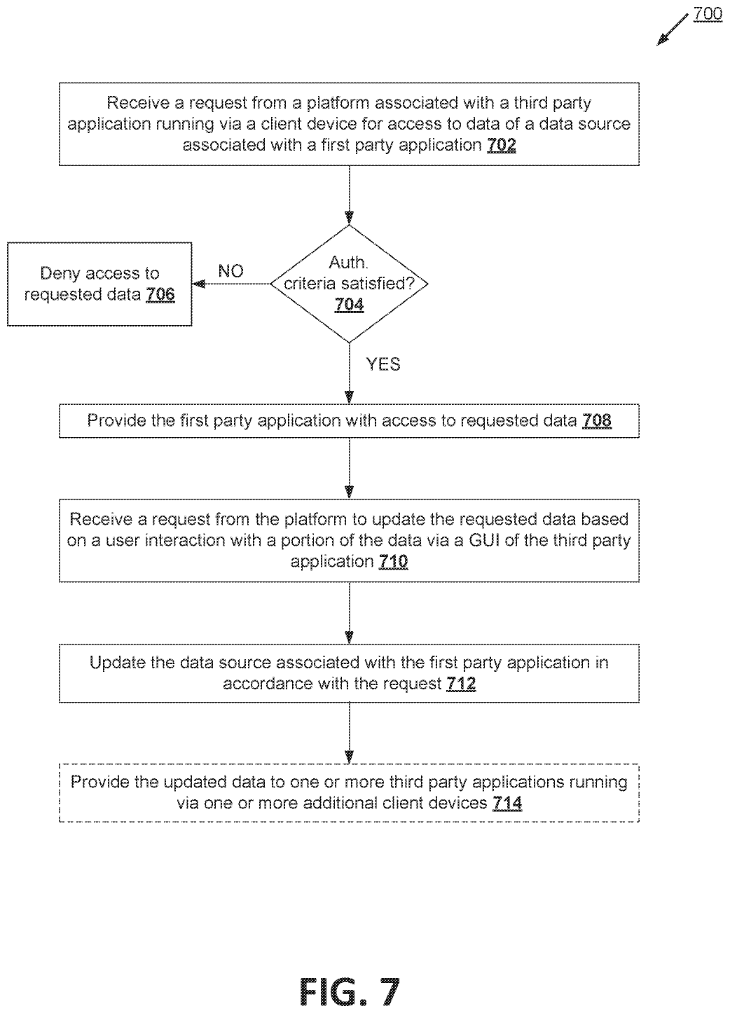

FIG. 7 depicts a flow diagram of another example method 700 for interactive data connectors for an electronic document at a platform, in accordance with implementations of the present disclosure. Method 700 can be performed by processing logic that can include hardware (circuitry, dedicated logic, etc.), software (e.g., instructions run on a processing device), or a combination thereof. In one implementation, some or all the operations of method 700 can be performed by one or more components of system 100 of FIG. 1. In some embodiments, some or all of the operations of method 700 can be performed by one or more components of server machine 150.

As indicated above, one or more operations of method 700 are performed by components of server machine 150, which provides users with access to application 151. Accordingly, for purposes of example and illustration, application 151, as described below, is referred to as the first party application 151 and application 121, as described below, is referred to as third party application 121.

At block 702, processing logic receives a request from a platform associated with a third party application running via a client device for access to data of a data source associated with a first party application. The computing system (e.g., server machine 150) associated with application 151 can receive the request from data connector engine 141, in accordance with previously described embodiments. At block 704, processing logic determines whether authorization data included with the request satisfies one or more authorization criteria. As described above, in some embodiments, the request from data connector engine 141 can include authorization data 254, in some embodiments. In such embodiments, application 151 can determine whether the authorization criteria are satisfied based on the authorization data 254, as described above. For example, the authorization data 254 can include an identifier associated with client device 102 and/or the user. Application 151 can compare the identifier of authorization data 254 to a set of identifiers that are authorized or permitted to access external data source 400, as described above. In another example, authorization data 254 can include a cryptographic key and/or an authorization token. Application 151 can provide the cryptographic key and/or the authorization token as input to a cryptographic function and can obtain one or more outputs indicating whether the client device 102 and/or the user is authorized or permitted to access the external data source 400. In other or similar embodiments, the request for data from data connector engine 141 does not include authorization data 254. In such embodiments, application 151 can request the authorization data 254 from data connector engine 141 (e.g., upon receiving the data access request).

Upon processing logic determining that the authorization criteria are not satisfied (e.g., the identifier is not included in the set of identifiers, the output of the cryptographic function indicates that the user is not authorized/permitted to access external data source 400, etc.), method 700 proceeds to block 706. At block 706, processing logic denies access to the requested data. In some embodiments, application 151 can transmit a notification to platform 120 and/or client device 102 indicating that client device 102 and/or the user is not authorized or permitted to access the data of external data source 400. Client device 102 can update UI 500 and/or 600 to include the notification in some embodiments.

Upon processing logic determining that the authorization criteria are satisfied (e.g., the identifier is included in the set of identifiers, the output of the cryptographic function indicates that the user is authorized/permitted to access external data source 400, etc.), method 700 proceeds to block 708. At block 708, processing logic provides the first party application with access to the requested data, in accordance with previously described embodiments. At block 710, processing logic receives a request from the platform to update the requested data based on a user interaction with a portion of the data via a UI of the third party application. The request can include an instruction from data update component 218 to update the data 252, as described above. At block 712, processing logic updates the data source associated with the first party application in accordance with the request. In some embodiments, application 151 can update the data by executing the instruction from data update component 218, in accordance with previously described embodiments.

At block 714, processing logic, optionally, provides the updated data to one or more third party applications running via one or more additional client devices. As described above, the user of client device 102 and/or another user of application 151 can update data of external data source 400 (e.g., using application tools of application 151). In such embodiments, application 151 can transmit a notification to data connector engine 141, as described herein. Data connector engine 141 can update UI element 512 and/or 614 based on the notification, as described above.

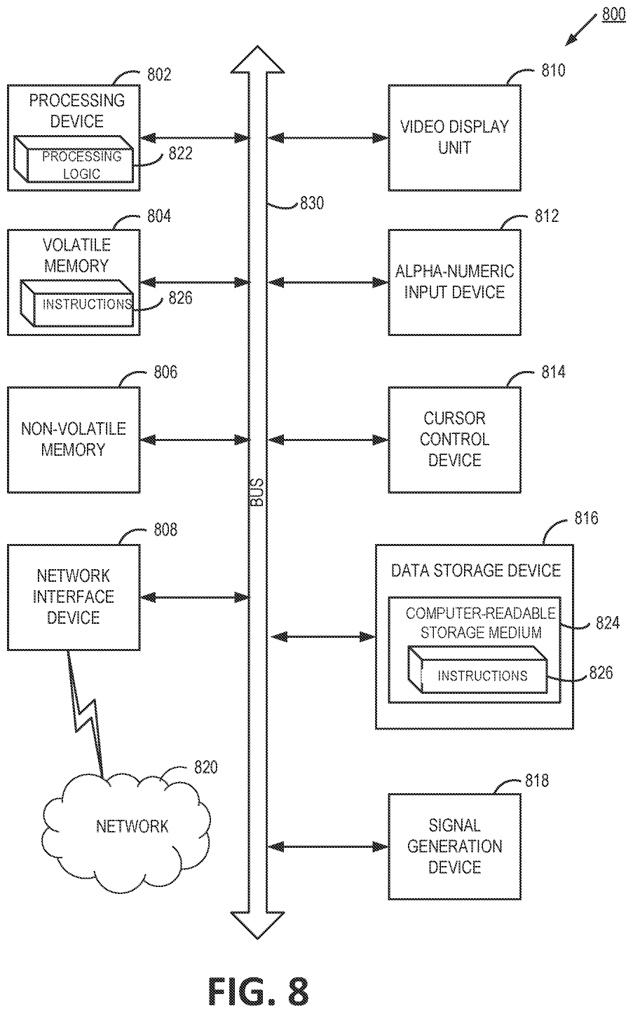

FIG. 8 is a block diagram illustrating an exemplary computer system 800, in accordance with implementations of the present disclosure. The computer system 800 can correspond to platform 120 and/or client devices 102A-N, described with respect to FIG. 1. Computer system 800 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

Processor (processing device) 802 represents one or more general-purpose processing devices such as a microprocessor, central processing unit, or the like. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application specific integrated circuit (ASIC), a field programmable gate array (FPGA), a digital signal processor (DSP), network processor, or the like. The processor 802 is configured to execute instructions 826 for performing the operations discussed herein. Instructions 805 can correspond to processing logic 822, which can include, but is not limited to, processing logic described with respect to FIGS. 3 and 7.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 818 can include a non-transitory machine-readable storage medium 824 (also computer-readable storage medium) on which is stored one or more sets of instructions 826 embodying any one or more of the methodologies or functions described herein. The instructions can also reside, completely or at least partially, within the main memory 804 and/or within the processor 802 during execution thereof by the computer system 800, the main memory 804 and the processor 802 also constituting machine-readable storage media. The instructions can further be transmitted or received over a network 820 via the network interface device 808.

In one implementation, the instructions 826 include instructions for providing fine-grained version histories of electronic documents at a platform. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method for a server computing device, the method comprising:
providing a client device with access to an electronic document using a user interface (UI) for a first application, wherein the electronic document includes a reference to a set of data associated with a second application;
upon detecting a first user interaction with a UI element associated with the reference to the set of data, updating the UI for the first application to include, in the electronic document, at least a portion of the set of data associated with the second application;
receiving a request to modify the set of data associated with the second application based on a second user interaction with the at least the portion of the set of data included in the electronic document; and
transmitting an instruction to a computing system associated with the second application to modify the at least the portion of the set of data in accordance with the request.

2. The method of claim 1, wherein updating the UI for the first application to include the at least the portion of the set of data in the electronic document comprises:
identifying, from a template library, a template associated with the second application that corresponds to the set of data,
wherein the at least the portion of the set of data is included according to the identified template.

3. The method of claim 1, further comprising:
determining whether the client device satisfies one or more authorization criteria associated with the second application, where the UI for the first application is updated based on the determination.

4. The method of claim 3, wherein determining whether the client device satisfies one or more authorization criteria associated with the second application comprises:
determining that the client device is associated with a user account of the second application; and
determining that an authorization process associated with the user account of the second application has completed.

5. The method of claim 1, wherein the reference to the set of data associated with the second application comprises a uniform resource locator (URL) associated with a web page that comprises the set of data.

6. The method of claim 1, wherein the UI element is a second UI element, and wherein the method further comprises:
determining that the electronic document comprises the reference to the set of data associated with the second application;
responsive to determining that the reference is supported by the second application, updating the UI for the first application to include a first UI element;
responsive to a user interaction with the first UI element, obtaining, from the second application, data associated with rendering the second UI element associated with the reference to the set of data; and
updating the UI for the first application to include the second UI element.

7. The method of claim 6, further comprising:
detecting an error associated with at least one of the second application, the at least the portion of the set of data associated with the second application, or the second UI element; and
responsive to the detection, updating the UI to replace the second UI element with the first UI element.

8. The method of claim 1, wherein detecting the first user interaction with the UI element comprises at least one of:
detecting that a user has engaged with the UI element via the UI, or
detecting that the user has hovered at least one of a mouse or cursor of a peripheral device of the client device to a region of the UI that is adjacent to the UI element.

9. The method of claim 1, wherein the UI for the first application is updated to include the at least the portion of the set of data with the reference to the set of data.

10. The method of claim 1, wherein the UI for the first application is updated to replace the reference to the set of data with the at least the portion of the set of data.

11. A system comprising:
a memory; and
a set of processing devices coupled to the memory, wherein the set of processing devices is to perform operations comprising:
providing a client device with access to an electronic document using a user interface (UI) for a first application, wherein the electronic document includes a reference to a set of data associated with a second application;
upon detecting a first user interaction with a UI element associated with the reference to the set of data, updating the UI for the first application to include, in of the electronic document, at least a portion of the set of data associated with the second application;
receiving a request to modify the set of data associated with the second application based on a second user interaction with the at least the portion of the set of data included in the electronic document; and
transmitting an instruction to a computing system associated with the second application to modify the at least the portion of the set of data in accordance with the request.

12. The system of claim 11, wherein updating the UI for the first application to include the at least the portion of the set of data in of the electronic document comprises:
identifying, from a template library, a template associated with the second application that corresponds to the set of data,
wherein the at least the portion of the set of data is included according to the identified template.

13. The system of claim 11, wherein the operations further comprise:
determining whether the client device satisfies one or more authorization criteria associated with the second application, where the UI for the first application is updated based on the determination.

14. The system of claim 13, wherein determining whether the client device satisfies one or more authorization criteria associated with the second application comprises:
determining that the client device is associated with a user account of the second application; and
determining that an authorization process associated with the user account of the second application has completed.

15. The system of claim 11, wherein the reference to the set of data associated with the second application comprises a uniform resource locator (URL) associated with a web page that comprises the set of data.

16. The system of claim 11, wherein the UI element is a second UI element, and wherein the operations further comprise:
determining that the electronic document comprises the reference to the set of data associated with the second application;
responsive to determining that the reference is supported by the second application, updating the UI for the first application to include a first UI element;
responsive to a user interaction with the first UI element, obtaining, from the second application, data associated with rendering the second UI element associated with the reference to the set of data; and
updating the UI for the first application to include the second UI element.

17. The system of claim 11, wherein the operations further comprise:
detecting an error associated with at least one of the second application, the at least the portion of the set of data associated with the second application, or the second UI element; and
responsive to the detection, updating the UI to replace the second UI element with the first UI element.

18. A non-transitory computer readable storage medium comprising instructions for a server that, when executed by a set of processing devices, cause the set of processing devices to perform operations comprising:
providing a client device with access to an electronic document using a user interface (UI) for a first application, wherein the electronic document includes a reference to a set of data associated with a second application;
upon detecting a first user interaction with a UI element associated with the reference to the set of data, updating the UI for the first application to include, in the electronic document, at least a portion of the set of data associated with the second application;
receiving a request to modify the set of data associated with the second application based on a second user interaction with the at least the portion of the set of data included in the electronic document; and
transmitting an instruction to a computing system associated with the second application to modify the at least the portion of the set of data in accordance with the request.

19. The non-transitory computer readable storage medium of claim 18, herein updating the UI for the first application to include the at least the portion of the set of data in the electronic document comprises:
identifying, from a template library, a template associated with the second application that corresponds to the set of data,
wherein the at least the portion of the set of data is included according to the identified template.

20. The non-transitory computer readable storage medium of claim 18, wherein the operations further comprise:
determining whether the client device satisfies one or more authorization criteria associated with the second application, where the UI for the first application is updated based on the determination.
